(19) United States
(12) Patent Application Publication
(10) Pub. No.: US 2015/0058402 A1
(43) Pub. Date: Feb. 26, 2015

(54) SERVER APPARATUS, CLIENT APPARATUS, SYSTEM, INFORMATION PROCESSING METHOD, AND STORAGE MEDIUM

(71) Applicant: Canon Kabushiki Kaisha, Tokyo (JP)

(72) Inventor: Norihisa Kishimoto, Kawasaki-shi (JP)

(21) Appl. No.: 14/460,192

(22) Filed: Aug. 14, 2014

(30) Foreign Application Priority Data
Aug. 20, 2013 (JP) 2013-170565

(51) Int. Cl. H04L 29/06; H04L 29/08

(52) U.S. Cl. CPC H04L 67/42; H04L 67/1097; H04L 67/06
USPC 709/203

(57) ABSTRACT

A server apparatus that connects to a first client apparatus and a second client apparatus includes a first notification unit that notifies the second client apparatus of a start message of an operation of a file in response to detection of a start request of the operation of the file from the first client apparatus, a second notification unit that notifies the second client apparatus of an end message of the operation of the file in response to detection of an end request of the operation of the file received from the first client apparatus, and a control unit that executes an operation of the file according to a start request of a subsequent operation of the file, wherein the start request is received by the second client apparatus after the start message is notified and reserved until the end message is notified.

### BACKGROUND

1. Field

Aspects of the present invention generally relate to a server apparatus, a client apparatus, a system, an information processing method, and a storage medium.

2. Description of the Related Art

Generally, a server message block (SMB), a common internet file system (CIFS), and a web-based distributed authoring and versioning (WebDAV) are well known as protocols for sharing a file among a plurality of devices through a network.

In each of the above protocols, a server storing a file is provided so that a client such as a personal computer (PC) accesses the server through a network. Then, the client can refer to, edit, add, or delete a file or a folder stored in the server. In the above-described protocols, there may be a case where a terminal B makes change on a file or a folder in the server while another terminal A is referring to that file or the folder. In this case, in general, the terminal A recognizes the change in the file or the folder by requesting and acquiring the latest information from the server.

In such a case, the terminal A cannot recognize the change on a real time basis. In order to solve the above problem, Japanese Patent Application Laid-Open No. 2012-79042 discussed a method in which the server and the client share attribute information of files or folders and terminal information. Then, when an operation is executed by one terminal, the server transmits an event to other terminals currently accessing to the server by managing terminal information of the terminals currently accessing thereto and attribute information of the files or the folders that are being operated.

However, with the above-described method, the server has to manage a list of the attribute information of the files or the folders and the terminal information of the terminals currently accessing to the server, and thus great time and effort will be required to search the managed information if the server is accessed by a large number of terminals.

### SUMMARY

Aspects of the present invention are generally directed to a technique which enables a client to recognize content of a change in a file or a folder on a real time basis.

According to an aspect of the present invention, a server apparatus includes a first notification unit configured to notify a second client apparatus of a start message of an operation of a file in response to a detection of a start request for the operation of the file from a first client apparatus, a second notification unit configured to notify the second client apparatus of an end message of the operation of the file in response to a detection of an end request for the operation of the file received from the first client apparatus, and a control unit configured to execute an operation of the file according to a start request of a subsequent operation of the file, received and reserved by the second client apparatus between when the start message has been notified and when the end message has been notified.

According to the aspect of the present invention, the client can recognize content of a change in a file or a folder on a real time basis.

Further features of the present disclosure will become apparent from the following description of exemplary embodiments with reference to the attached drawings.

### BRIEF DESCRIPTION OF THE DRAWINGS

FIG. 1 is a diagram illustrating an example of a system configuration of a printing system.

FIG. 2 is a block diagram illustrating an example of a hardware configuration of an image forming apparatus.

FIG. 3 is a block diagram illustrating an example of a hardware configuration of a storage server and a personal computer (PC).

FIG. 4 is a block diagram illustrating an example of a software configuration of the image forming apparatus.

FIG. 5 is a block diagram illustrating an example of a software configuration of the storage server.

FIG. 6 is a diagram illustrating an example of a user interface (UI) displayed on an operation panel when the image forming apparatus refers to a folder within the storage server.

FIG. 7A is a diagram illustrating an example of an event that is to be transmitted when an operation of a file is started. FIG. 7B is a diagram illustrating an example of an event that is to be transmitted when an operation of a file is ended.

FIG. 8 is a sequence diagram illustrating an example of communications between the storage server, the image forming apparatus, and the PC.

FIG. 9 is a flowchart illustrating an example of information processing by the storage server for executing an event notification.

FIG. 10A is a flowchart illustrating an example of information processing when the file is operated through the operation panel. FIG. 10B is a flowchart illustrating an example of information processing when an event is received from the storage server.

### DESCRIPTION OF THE EMBODIMENTS

Various exemplary embodiments will be described in detail below with reference to the drawings.

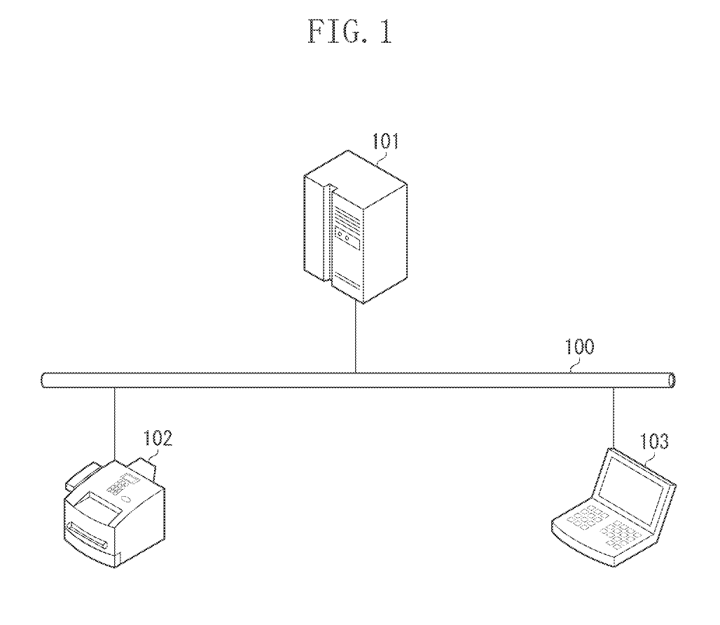

FIG. 1 is a diagram illustrating an example of a system configuration of a printing system.

In FIG. 1, a storage server 101, an image forming apparatus 102, and a PC 103 are connected to a local area network (LAN) 100.

The storage server 101 opens all or a part of files or folders stored therein to other terminals connected to the LAN 100 by using a protocol such as the SMB, the CIFS, or the WebDAV. In the printing system, the terminals connected to the LAN 100 can share the files and the folders in the storage server 101. For example, the image forming apparatus 102 or the PC 103 is allowed to refer to, edit, add, delete, or transfer the files or the folders stored in the storage server 101. In addition, a file sharing protocol used on a network, protocols other than the SMB, the CIFS, and the WebDAV, may be also employed. Further, other network types such as the internet may be employed instead of the LAN 100.

The PC 103 serves as an example of a first client apparatus. The image forming apparatus 102 serves as an example of a second client apparatus.

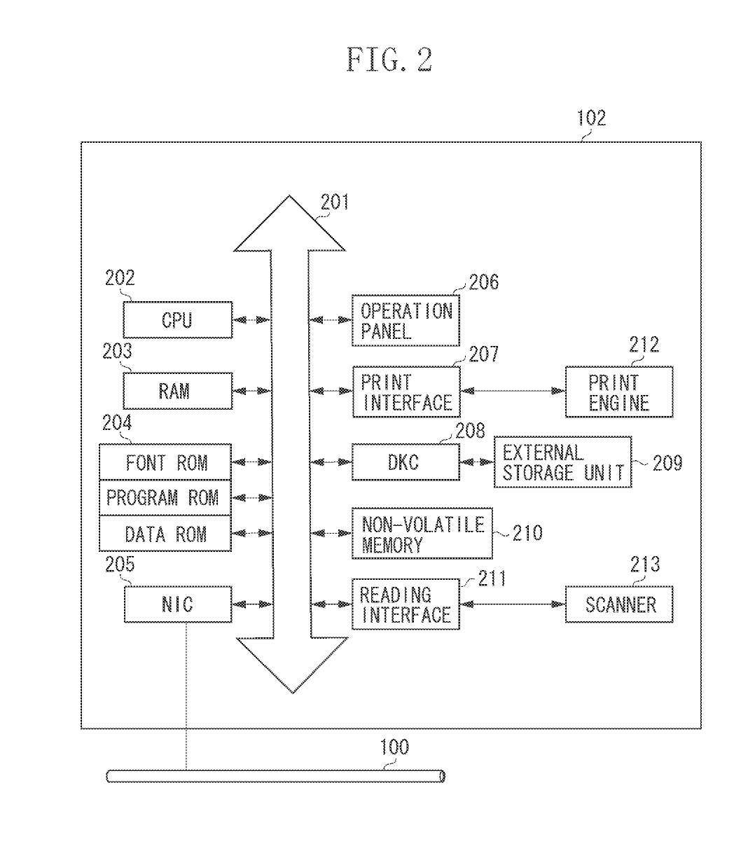

FIG. 2 is a diagram illustrating an example of a hardware configuration of the image forming apparatus 102.

In FIG. 2, a central processing unit (CPU) 202 generally controls the access to various devices connected to a system bus 201 based on a program stored in a program read only memory (ROM) of a ROM 204 or an external storage unit 209. The CPU 202 outputs an image signal as output information to a printing unit (print engine) 212 connected thereto, via a print interface 207. Further, the CPU 202 controls an image signal input from a reading unit (scanner) 213 connected thereto via a reading interface 211.

A control program that can be executed by the CPU 202 is stored in the program ROM of the ROM 204. Further, font data including outline font data used for generating the output information is stored in a font ROM of the ROM 204. Furthermore, information used for executing the processing is stored in a data ROM of the ROM 204.

A network interface card (NIC) 205 is connected to the CPU 202, so that the CPU 202 can communicate with a computer or other image forming apparatuses on the network via the NIC 205.

A random access memory (RAM) 203 mainly functions as a main memory or a work area of the CPU 202, and a memory capacity thereof can be expanded by an option RAM connected to an expansion port. The RAM 203 is used as a region for rasterizing output information or a region for storing environmental data.

Access to the external storage unit 209 such as a hard disk (HDD) or an integrated circuit (IC) card is controlled by a disk controller (DKC) 208. The hard disk is used as a storage region for storing application programs, font data, and form data, and a job storage region for temporarily spooling a print job, and controlling the spooled job externally. Further, the hard disk is also used as a box data storage region where the image data read by the scanner 213 and the image data of the print job are stored as box data, so as to be referred to or printed therefrom via the network. In the present exemplary embodiment, the hard disk is employed as the external storage unit 209. Then, various logs such as a job log and an image log are stored in the hard disk.

A user can input various kinds of information by using software keys of an operation panel 206. The above-described image forming apparatus 102 has one external storage unit 209. However, it is not limited thereto, and the image forming apparatus 102 may have at least one external storage unit, and a plurality of external memories including an option font card storing fonts in addition to built-in fonts, and a memory storing programs for interpreting a printer control language having a different language system may be connected to the image forming apparatus 102.

Various kinds of setting information set through the operation panel 206 are stored in a non-volatile memory 210. Further, various optional expansion units such as a finisher having a stapling function and a sorting function, and a two-sided printing device for realizing a two-sided printing function can be attached to the image forming apparatus 102. These devices are controlled by the CPU 202.

The CPU 202 executes the processing based on the program, so that the software configuration of the image forming apparatus 102 and processing of the flowchart described below relating to the image forming apparatus 102 will be realized.

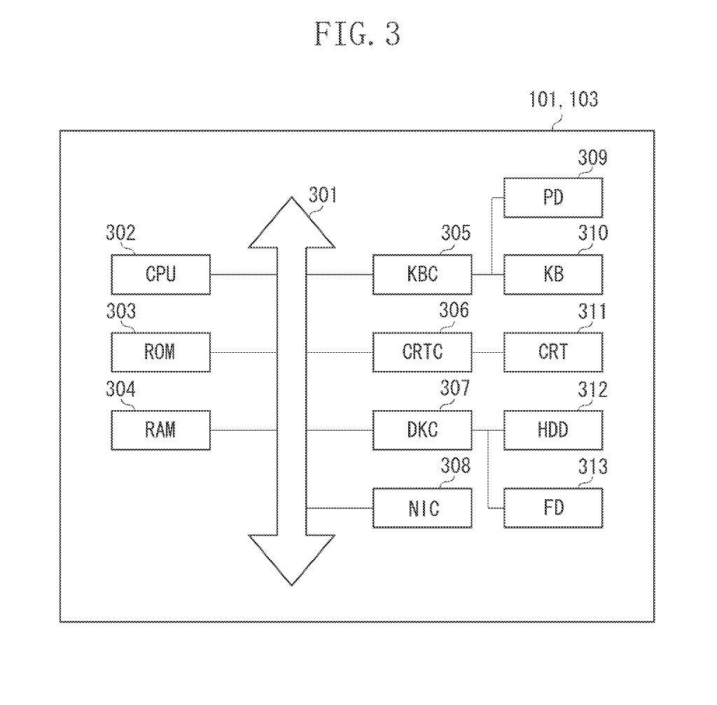

FIG. 3 is a block diagram illustrating an example of a hardware configuration of the storage server 101 and the PC 103.

In FIG. 3, a CPU 302 controls various devices connected to a system bus 301.

A program of a basic input-output system (BIOS) and a boot program are stored in a ROM 303.

A RAM 304 is used as a main storage unit of the CPU 302.

A keyboard controller (KBC) 305 executes processing relating to input information from a pointing device (PD) 309 such as a mouse, or a keyboard (KB) 310.

A display control unit (cathode-ray tube controller (CRTC)) 306 includes a video memory, and rasterizes image data on the video memory to output the image data rasterized on the video memory to a cathode-ray tube (CRT) 311 as a video signal according to an instruction from the CPU 302. In addition, in FIG. 3, although the CRT 311 is exemplified as a display unit, other types of display unit such as a liquid crystal display unit can also be employed.

A disk controller (DKC) 307 enables access to a hard disk (HDD) 312 and a flexible disk (FD) 313.

A network interface card (NIC) 308 enables connection to a network to execute information communication via the network.

A program of an operating system (OS) and programs of various applications operating on the OS are stored in the HDD 312. For example, a folder is created in the HDD 312, so that a file is stored therein. The HDD 312 serves as an example of a storage region.

In the above-described configuration, when the power of the apparatus is turned ON, according to a boot program stored in the ROM 303, the CPU 302 reads the program of the OS from the HDD 312 to the RAM 304, and executes the processing to realize the functions of the apparatus.

In other words, the CPU 302 of the storage server 101 executes the processing based on the program, so as to realize the software configuration of the storage server 101 and the below-described processing of the flowchart relating to the storage server 101. The same is also applicable to the PC 103.

The storage server 101 opens information of the files and the folders stored in the HDD 312 to other terminals on the LAN 100 via the NIC 308.

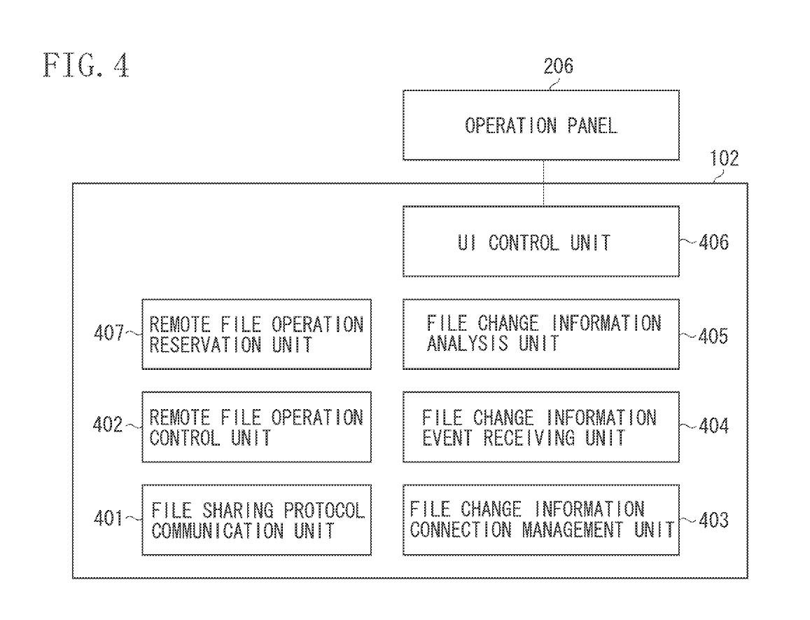

FIG. 4 is a block diagram illustrating an example of a software configuration of the image forming apparatus 102.

A file sharing protocol communication unit 401 controls the communication based on the file sharing protocol such as the SMB, the CIFS, or the WebDAV. Practically, the file is remotely operated through the operation panel 206. When the user provides an instruction for operating the file or the folder stored in the storage server 101 through the operation panel 206, the instruction is notified to a remote file operation control unit 402 via a UI control unit 406.

The remote file operation control unit 402 receives the instruction and operates the file via the file sharing protocol communication unit 401.

On the other hand, a file change information connection management unit 403 maintains connection for transmitting and receiving an event of file operation information to/from the storage server 101. This connection is established by the protocol different from the above-described file sharing protocol.

A file change information event receiving unit 404 executes the processing relating to the event received from the storage server 101. In the present exemplary embodiment, the file change information connection management unit 403 is provided separately from the file sharing protocol communication unit 401. However, in practice, the file change information connection management unit 403 may be included in the file sharing protocol communication unit 401.

A file change information analysis unit 405 analyzes the received event information, specifies a file or a folder stored in the storage server 101, stores the file or the folder by determining the status thereof, and displays the information of a currently-operated file on the operation panel 206 through the UI control unit 406.

Such a file can be operated similarly to some other files. Therefore, the user can reserve a subsequent operation of the currently-operated file or the folder through the UI control unit 406 via a remote file operation reservation unit 407.

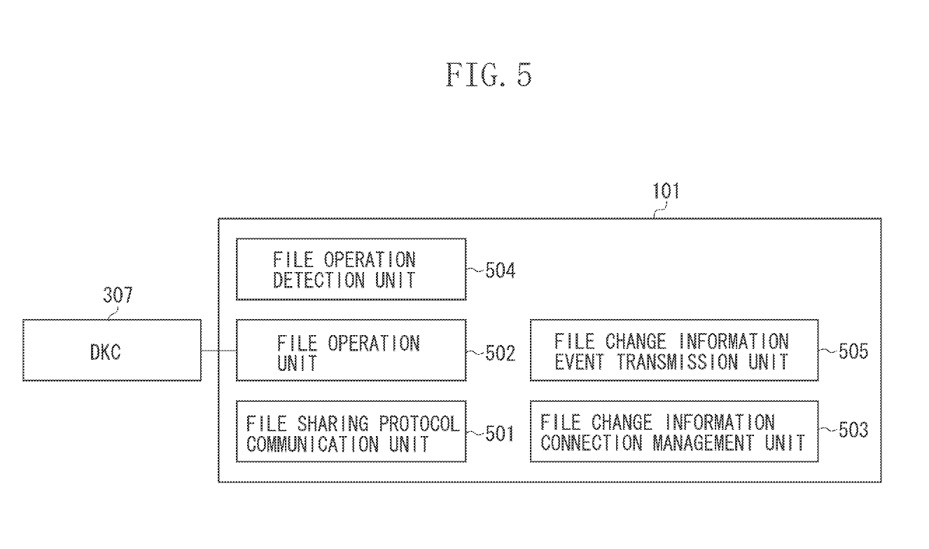

FIG. 5 is a block diagram illustrating a software configuration of the storage server 101.

A file sharing protocol communication unit 501 controls the communication based on the file sharing protocol such as the SMB, the CIFS, or the WebDAV.

A file operation unit 502 executes an operation of a file or a folder requested from the terminal on the network, so that the file or the folder stored in the storage server 101 is actually operated via the DKC 307.

A file change information connection management unit 503 maintains connection for transmitting and receiving an event of file operation information to/from the terminal. When the file operation unit 502 starts operating the file, a file operation detection unit 504 detects that operation. The information of the file or the folder and the operation information thereof are transmitted to the terminal via the above-described connection.

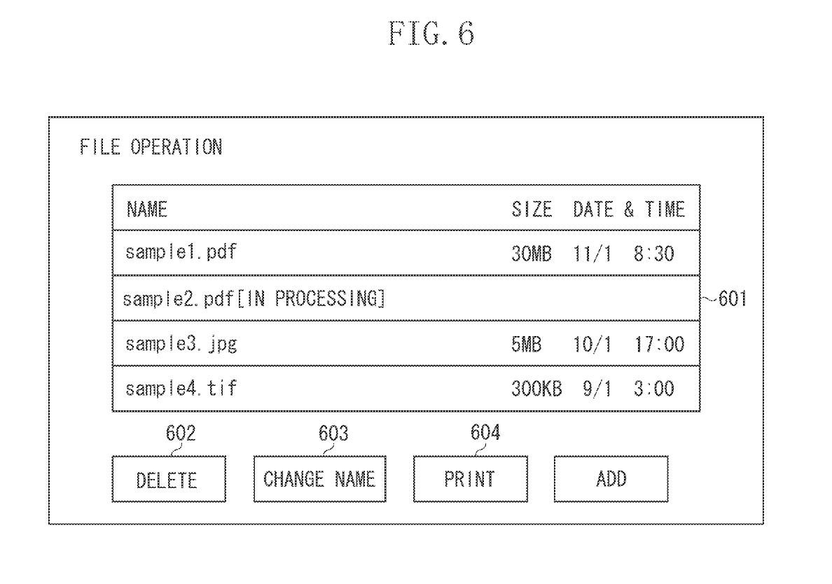

FIG. 6 is a diagram illustrating an example of a UI displayed on the operation panel 206 when the image forming apparatus 102 refers to a folder stored in the storage server 101. The UI includes a file list screen 601 for referring to a list of files saved in a folder, and buttons for executing various operations such as “delete”, “change name”, “print”, and “add” with respect to each of the files. Operations and buttons other than the above may also be provided.

In FIG. 6, “sample1.pdf”, “sample2.pdf”, “sample3.jpg”, and “sample4.tif” are displayed as examples of a plurality of files stored in the storage server 101. Then, it is assumed that the file “sample2.pdf” is being operated by the PC 103. Any kind of operation such as “add”, or “edit” can be executed thereon.

According to the processing according to the present exemplary embodiment, as illustrated in the file list screen 601, a user of the image forming apparatus 102 can also refer to a file that is being operated in the storage server 101 in the list of files. Further, as for the currently-operated file displayed on the file list screen 601, the user can also press a delete button 602, a change name button 603, or a print button 604.

Hereinafter, an example of the event transmitted when the file is operated in the storage server 101 will be described. In the present exemplary embodiment, the event is assumed to be transmitted through the web communication in an extensible markup language (XML) format. However, other event transmission mode may also be employed therefor.

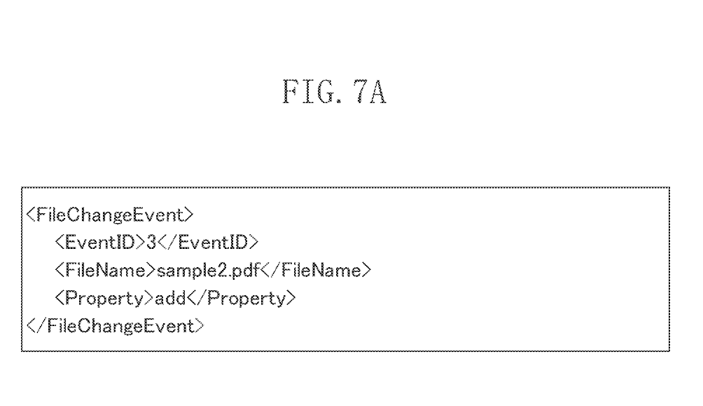

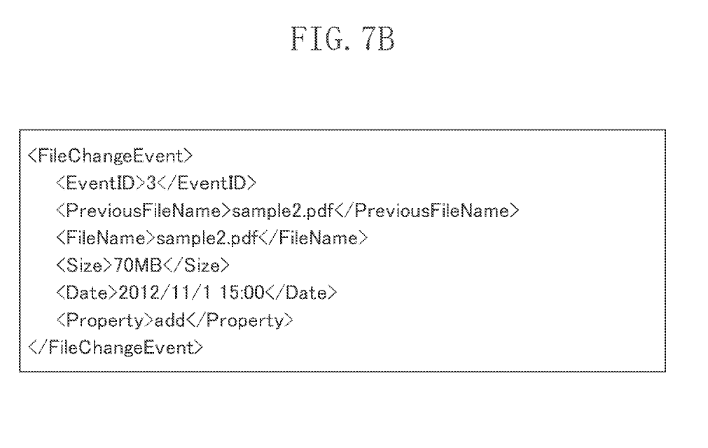

FIG. 7A is a diagram illustrating an example of an event transmitted when the operation of the file is started. Identification (ID) of the event to be notified is set to a tag “EventID”. A file name of the currently-operated file is set to a tag “FileName”. Content of the operation is set to a tag “Property”. The content of the operation in the present exemplary embodiment is to add a file.

The event illustrated in FIG. 7A is an example of a start message.

FIG. 7B is a diagram illustrating an example of an event transmitted when the file operation is ended. The tags “EventID” and “Property” are common to those described in the event of starting the file operation. The same ID as that set when starting the file operation is set to “EventID” in FIG. 7B. Information included in a tag “PreviousFileName” becomes useful when the file name is changed. In the example of the present exemplary embodiment, a file name before being changed is set thereto. A file name after the operation is set to a tag “FileName”. If the file name has been changed, a changed file name is set to the tag “FileName”. A size of the file after the file operation is set to a tag “Size”. A time stamp of the file is set to a tag “Date”.

The event illustrated in FIG. 7B is an example of an end message.

Next, communication processing according to the present exemplary embodiment will be described.

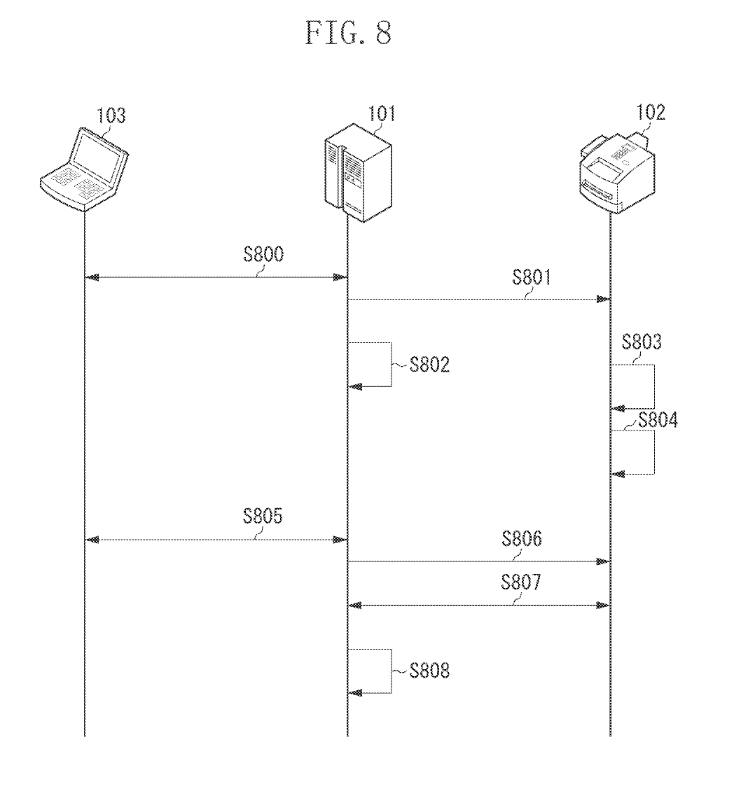

FIG. 8 is a sequence diagram illustrating an example of communication between the storage server 101, the image forming apparatus 102, and the PC 103.

In step S800, the PC 103 starts the operation of a file in the storage server 101. When the storage server 101 receives a start request of the operation from the PC 103, in step S801, the storage server 101 makes a notification by transmitting the message illustrated in FIG. 7A to the image forming apparatus 102 via the connection. Then, in step S802, the image forming apparatus 102 actually starts operating the file. The processing in step S801 is an example of a first notification.

At this point, in step S803, the image forming apparatus 102 displays information indicating a list of files stored in the storage server 101 on the operation panel 206. As illustrated in the file list screen 601 of FIG. 6, the user can refer to the currently-operated file among the list of files.

Next, in step S804, when the user selects the currently-operated file on the operation panel 206 to press any of the buttons 602 through 604, the image forming apparatus 102 stores content of the operation of the specified file as a reserved subsequent operation.

Thereafter, in step S805, the PC 103 ends the file operation. After the storage server 101 receives the end request of the operation from the PC 103, in step S806, the storage server 101 transmits the message of FIG. 7B via the connection to notify that the operation of the file is ended. The processing in step S806 is an example of a second notification.

In step S807, the image forming apparatus 102 receives the notification and requests the operation of the specified file based on the content of the subsequent operation stored in step S804.

In step S808, the storage server 101 executes the operation requested for the file. The operations requested to the file include deleting the file from the HDD 312 of the storage server 101, changing the file name of the file, and printing the file through the image forming apparatus 102. The file is an example of data. Further, the file name is an example of a data name.

In the present exemplary embodiment, the image forming apparatus 102 is assumed to open the file list screen 601 illustrated in FIG. 6 after receiving the event notification from the storage server 101. However, the operation may be executed in a reverse order. In this case, the currently-operated file may be dynamically displayed on the file list screen 601 provided on the image forming apparatus 102 that has received the event notification.

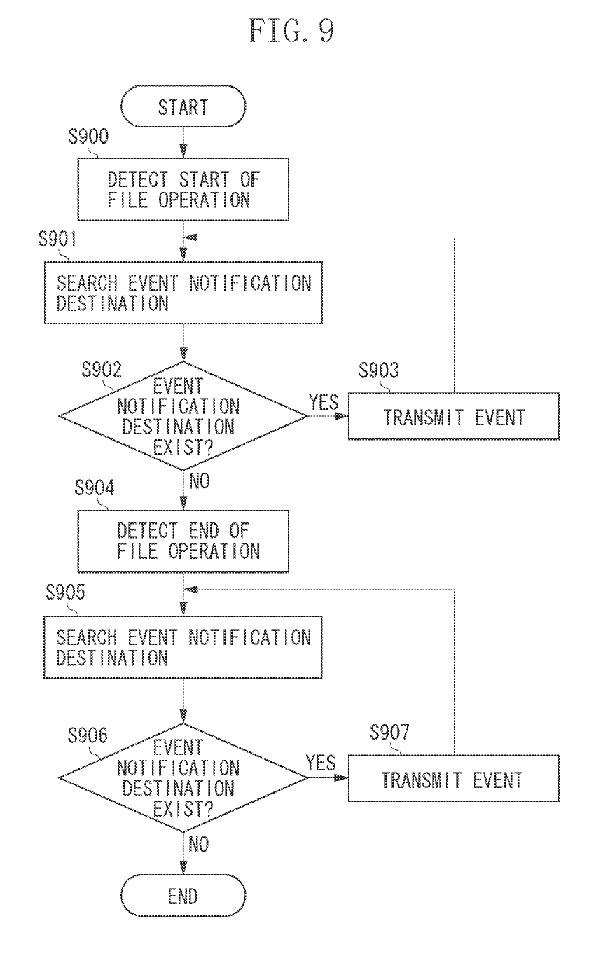

Subsequently, the processing of the storage server 101 will be described in detail with reference to FIGS. 5 and 9. FIG. 9 is a flowchart illustrating an example of the information processing for notifying an event of the storage server 101.

In step S900, the file operation detection unit 504 detects that the file operation unit 502 remotely starts operating the file.

Then, in step S901, the file change information event transmission unit 505 searches for an event notification destination. In step S902, the file change information event transmission unit 505 determines whether the event notification destination exists. If the event notification destination exists (YES in step S902), the processing proceeds to step S903. In step S903, the file change information event transmission unit 505 transmits the message illustrated in FIG. 7A. The event notification destination may be more than one. In such a case, the file change information event transmission unit 505 repeatedly searches for an event notification destination by returning to step S901. At this time, in a case where the storage server 101 has established and maintained connection for transmitting and receiving the event of file operation information to/from a device, the storage server 101 stores the event notification destination in the RAM 203, for example. In other words, when the event notification destination exists, this indicates that there is a device that has established connection for transmitting and receiving an event notification to/from the storage server 101.

In step S902, if the event notification destination does not exist (NO in step S902), the processing proceeds to step S904. In step S904, the file operation detection unit 504 detects the end of the file operation. In step S905, the file change information event transmission unit 505 searches the event notification destination. In step S906, the file change information event transmission unit 505 determines whether the event notification destination exists. If the event notification destination exists (YES in step S906), the processing proceeds to step S907. In step S907, the file change information event transmission unit 505 transmits the message illustrated in FIG. 7B. In the same manner as in the file operation starting period, when a plurality of the event notification destinations exists, the file change information event transmission unit 505 transmits the message to all of the event notification destinations. If the event notification destination does not exist (NO in step S906), the file change information event transmission unit 505 does not execute any processing but ends the processing illustrated in FIG. 9.

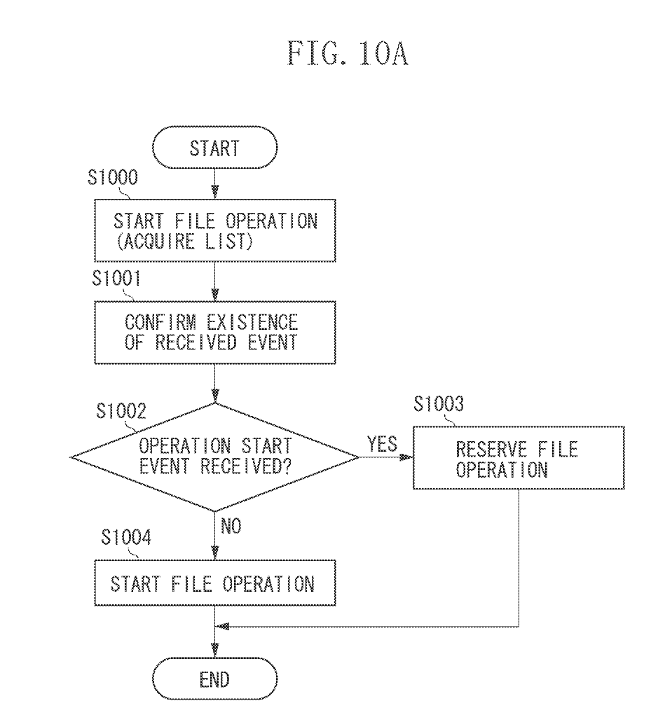

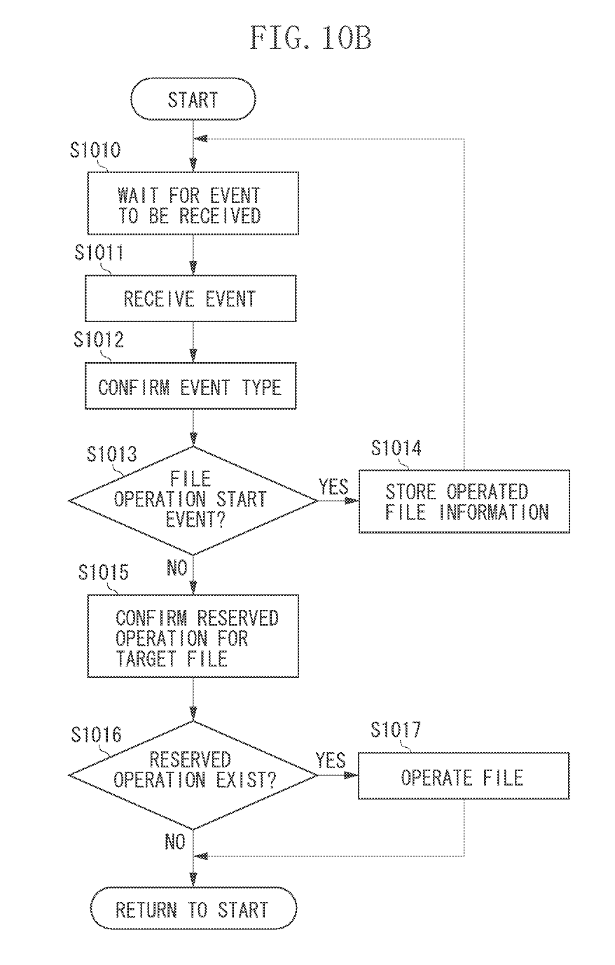

Next, the processing of the image forming apparatus 102 will be described in detail with reference to FIGS. 4, 10A, and 10B.

FIG. 10A is a flowchart illustrating an example of the information processing when a file is operated through the operation panel 206.

In step S1000, the file stored in the storage server 101 is operated via the UI control unit 406. In step S1001, the file change information analysis unit 405 confirms receipt of information of a file operation start event. In step S1002, the file change information analysis unit 405 determines whether the information thereof is received.

If the file operation start event is received (YES in step S1002), the processing proceeds to step S1003. In step S1003, the remote file operation reservation unit 407 reserves the content of the file operation because it is not possible to execute the file operation immediately. On the other hand, if the file operation start event is not received (NO in step S1002), the processing proceeds to step S1004. In step S1004, the remote file operation control unit 402 starts the file operation immediately.

FIG. 10B is a flowchart illustrating an example of the information processing when the event is received from the storage server 101.

In step S1010, the file change information event receiving unit 404 waits for the message of FIG. 7A to be received from the storage server 101. In step S1011, the file change information event receiving unit 404 receives the event. In step S1012, the file change information event receiving unit 404 confirms a type of the event. In step S1013, the file change information event receiving unit 404 determines whether the received event is the file operation start event. If the received event is the file operation start event as illustrated in FIG. 7A (YES in step S1013), the processing proceeds to step S1014. In step S1014, the file change information analysis unit 405 analyzes the content of the message, specifies the file that is being operated (or being changed), and stores the information thereof. If the received event is the message illustrated in FIG. 7B (NO in step S1013), the file change information analysis unit 405 confirms the change in the file. Then, in step S1015, the remote file operation reservation unit 407 searches for a reserved operation. In step S1016, the remote file operation reservation unit 407 determines whether the reserved operation exists. If the reserved operation exists (YES in step S1016), the processing proceeds to step S1017. In step S1017, the remote file operation control unit 402 starts the operation reserved for the specified file. If the reserved operation does not exist (NO in step S1016), the remote file operation reservation unit 407 does not execute any processing but returns to step S1010 to wait for the event to be received.

Additional embodiments can also be realized by a computer of a system or apparatus (or devices such as a CPU or MPU) that reads out and executes a program recorded on a memory device to perform the above-described functions, and by a method, the steps of which are performed by a computer of a system or apparatus by, for example, reading out and executing a program recorded on a memory device to perform the above-described functions. For this purpose, the program is provided to the computer for example via a network or from a recording medium of various types serving as the memory device (e.g., computer-readable medium).

As described above, according to each of the exemplary embodiments, the client can recognize the content of a change in files or folders on a real time basis.

Further, the storage server 101 can notify the PC 103 of a change in files or folders without the need for managing attribute information or terminal information being accessed.

Furthermore, because a file or a folder being operated by one terminal can be operated by other terminal in a manner similar to some other files or folders, the user does not have to wait in front of the device until the file operation is ended.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-170565 filed Aug. 20, 2013, which is hereby incorporated by reference herein in its entirety.

What is claimed is:

1. A server apparatus capable of connecting to a first client apparatus and a second client apparatus, comprising:
a first notification unit configured to notify the second client apparatus of a start message of an operation of a file in response to a detection of a start request for the operation of the file from the first client apparatus;
a second notification unit configured to notify the second client apparatus of an end message of the operation of the file in response to a detection of an end request for the operation of the file received from the first client apparatus; and
a control unit configured to execute an operation of the file according to a start request of a subsequent operation of the file, received and reserved by the second client apparatus between when the start message has been notified and when the end message has been notified.

2. The server apparatus according to claim 1,
wherein the control unit starts the operation of the file according to the start request from the first client apparatus, ends the operation of the file according to the end request from the first client apparatus, and executes the operation of the file according to the start request of the subsequent operation from the second client apparatus.

3. The server apparatus according to claim 1,
wherein the first notification unit searches information of an event notification destination when the start request of the operation of the file from the first client apparatus is detected, and notifies the second client apparatus of the start message of the operation of the file in a case where information indicating that connection to the second client apparatus has been established is present as the information of the event notification destination.

4. The server apparatus according to claim 1,
wherein the second notification unit searches information of an event notification destination when the end request of the operation of the file from the first client apparatus is detected, and notifies the second client apparatus of the end message of the operation of the file in a case where information indicating that connection to the second client apparatus has been established is present as the information of the event notification destination.

5. The server apparatus according to claim 1,
wherein, according to the start request of the subsequent operation, the control unit executes an operation for deleting the file from a storage unit of the server apparatus as the operation of the file.

6. The server apparatus according to claim 1,
wherein, according to the start request of the subsequent operation, the control unit executes an operation for changing a file name of the file as the operation of the file.

7. The server apparatus according to any one of claim 1,
wherein the second client apparatus is an image forming apparatus;
wherein the control unit executes, according to the start request of the subsequent operation, an operation for causing the image forming apparatus to print the file as the operation of the file.

8. A client apparatus capable of connecting to a server apparatus, comprising:
a display unit configured to display a screen including a list of a plurality of files stored in the server apparatus; and
a receiving unit configured to receive a notification of a start message of an operation of one file from among a plurality of the files from the server apparatus;
wherein, when the notification of the start message of the operation of the file is received by the receiving unit, the display unit displays the file on which the operation is being executed from among the list of a plurality of the files and displays information indicating that the operation is being executed on the file.

9. The client apparatus according to claim 8, further comprising:
a reservation unit configured to reserve an operation of the file in a case where the file on which the operation is being executed is selected from among the list of the plurality of the files and the operation of the file is requested.

10. The client apparatus according to claim 9, further comprising a control unit,
wherein the receiving unit further receives a notification of an end message of the operation of the file from the server apparatus, and
wherein, in a case where the notification of the end message of the operation of the file is received by the receiving unit, the control unit is configured to control and execute the operation of the file reserved by the reservation unit.

11. The client apparatus according to claim 8,
wherein the receiving unit receives the notification of the start message of the operation of one file from among the plurality of the files from the server apparatus via a connection established with the server apparatus.

12. A system comprising:
a server apparatus;
a first client apparatus; and
a second client apparatus,
wherein the server apparatus includes:
a first notification unit configured to notify the second client apparatus of a start message of an operation of a file when a start request of the operation of the file from the first client apparatus is detected;
a second notification unit configured to notify the second client apparatus of an end message of the operation of the file when an end request of the operation of the file from the first client apparatus is detected; and
a control unit configured to execute an operation of the file according to a start request of a subsequent operation of the file, received and reserved by the second client apparatus between when the start message has been notified and when the end message has been notified,
wherein the second client apparatus includes:
a display unit configured to display a screen including a list of a plurality of files stored in the server apparatus, and
a receiving unit configured to receive a notification of a start message of an operation of one file from among the plurality of the files from the server apparatus,
wherein the display unit displays, when the notification of the start message of the operation of the file is received by the receiving unit, the file on which the operation is being executed from among the list of the plurality of the files and displays information indicating that the operation is being executed on the file.

13. An information processing method executed by a server apparatus, comprising:
providing notification to a second client apparatus of a start message of an operation of a file when a start request of the operation of the file from a first client apparatus is detected;
notifying, as a second notification, the second client apparatus of an end message of the operation of the file when an end request of the operation of the file from the first client apparatus is detected; and
operating the file according to a start request of a subsequent operation of the file, received and reserved by the second client apparatus during when the start message has been notified and when the end message has been notified.

14. An information processing method performed by a client apparatus, comprising:
displaying a screen including a list of a plurality of files stored in a server apparatus; and
receiving a notification of a start message of an operation of one file from among the plurality of the files from the server apparatus;
wherein, when the notification of the start message of the operation of the file is received, the file on which the operation is being executed is specified from among the list of the plurality of the files, and information indicating that the operation is being executed on the file is displayed.

15. An information processing method of a system including a server apparatus, a first client apparatus, and a second client apparatus, the information processing method comprising:
providing notification to the second client apparatus of a start message of an operation of a file when a start request of the operation of the file from the first client apparatus is detected;
notifying, as a second notification, the second client apparatus of an end message of the operation of the file when an end request of the operation of the file from the first client apparatus is detected;
controlling execution of an operation of the file according to a start request of a subsequent operation of the file, received and reserved by the second client apparatus between when the start message has been notified and when the end message has been notified;
displaying a screen including a list of a plurality of files stored in the server apparatus; and
receiving a notification of a start message of an operation of one file from among the plurality of the files from the server apparatus;
wherein, when the notification of the start message of the operation of the file is received, the file on which the operation is being executed is specified from among the list of the plurality of the files, and information indicating that the operation is being executed on the file is displayed.

16. A non-transitory computer-readable storage medium storing a program for causing a computer to execute a method, the method comprising:
providing notification to a second client apparatus of a start message of an operation of a file when a start request of the operation of the file from a first client apparatus is detected;
notifying, as a second notification, the second client apparatus of an end message of the operation of the file when an end request of the operation of the file from the first client apparatus is detected; and
operating the file according to a start request of a subsequent operation of the file, received and reserved by the second client apparatus during when the start message has been notified and when the end message has been notified.

17. A non-transitory computer-readable storage medium storing a program for causing a computer to execute a method, the method comprising:
displaying a screen including a list of a plurality of files stored in a server apparatus; and
receiving a notification of a start message of an operation of one file from among the plurality of the files from the server apparatus;
wherein, when the notification of the start message of the operation of the file is received, the file on which the operation is being executed is specified from among the list of the plurality of the files, and information indicating that the operation is being executed on the file is displayed.
